(19) United States
(12) Patent Application Publication
(10) Pub. No.: US 2026/0030364 A1
(43) Pub. Date: Jan. 29, 2026

(54) VULNERABILITY ANALYSIS DEVICE AND METHOD BASED ON CONTRASTIVE LEARNING FOR ANALYZING VULNERABILITY OF MODEL REPLICATION FOR ARTIFICIAL INTELLIGENCE CLASSIFICATION MODELS

(71) Applicant: Korea University Research and Business Foundation, Seoul (KR)

(72) Inventors: Sang Kyun LEE, Hanam-si (KR); Jeong Hyun LEE, Seoul (KR); Sung Min HAN, Seoul (KR)

(21) Appl. No.: 19/279,428

(22) Filed: Jul. 24, 2025

(30) Foreign Application Priority Data
Jul. 24, 2024 (KR) 10-2024-0097579

(51) Int. Cl. G06F 21/57

(52) U.S. Cl. CPC G06F 21/577; G06F 2221/033

(57) ABSTRACT

The present disclosure relates to vulnerability analysis methods and devices for model replication of a target model, which is an artificial intelligence (AI)-based classification model, the method comprising: acquiring a queried dataset by querying a query obtained by sampling a part of a pre-prepared unqueried dataset on the target model, and training a clone model for the target model, wherein the method comprises: training the clone model in different ways according to the unqueried dataset and the dataset; further training the clone model to minimize cross entropy between a classification result of the clone model and a classification result of the target model; and analyzing the vulnerability of the model replication of the target model according to whether the clone model for the target model is generated with a query within a preset total query budget.

### CROSS REFERENCE TO RELATED APPLICATIONS

This application claims priority to Korean Patent Application No. 10-2024-0097579, filed on Jul. 24, 2024, in the Korean Intellectual Property Office, which is incorporated by reference herein in its entirety.

### FIELD

The present disclosure relates to a vulnerability analysis device and a method based on contrastive learning for analyzing a vulnerability of model replication for artificial intelligence (AI) classification models.

### BACKGROUND OF THE RELATED ART

The AI-based classification system solves the classification problem in the form of a black box. Here, the black box form means a form in which all information on the AI model providing a service, such as the structure of the classification model, training data, training parameters, and hyperparameters, is hidden from the outside, and the user may use the classification model by receiving the classification result for the corresponding input only when the user gives the AI model the input data point as a query.

In the case of the AI-based classification model, a very high cost is consumed for building a dataset for training, and the AI model that has completed training is considered an intellectual property with high added value. Therefore, many AI-based services operate the system in the form of the aforementioned black box to prevent such AI model from being exposed to the outside.

On the other hand, recently, attempts to apply the AI model to various domains have been made. In order to train the AI model, a high-cost infrastructure for collecting a large amount of training data, labeling, and training operations is required, and the AI model that has been trained through such infrastructure is an intellectual property with very high added value. Therefore, a model stealing attack targeting a black box-type AI model acts as a great threat to service providers, and research on model stealing attacks and defense techniques is actively underway.

However, conventional model stealing attack techniques have a limitation in that a very large number of queries are required to achieve high performance of a clone model.

In addition, since the conventional model stealing attack techniques train a clone model through supervised learning using a cross-entropy based loss function, a process of transmitting a plurality of queries and receiving the output of the target model, that is, a query process, to secure a data point labeled only through the output of the target model, which is the target model to be replicated, should be repeated, which leads to an increase in attack cost and likelihood of an attack being detected.

In addition, in the case of the conventional model stealing attack techniques, since the class imbalance problem existing on the queried dataset is not considered, there is a limitation in achieving high performance of the clone model.

Therefore, it is necessary to study how to analyze the vulnerability of the AI-based classification system to model replication.

### SUMMARY

The present disclosure solves the above problems, and an object of the present disclosure is to provide a vulnerability analysis device and method based on contrastive learning for model replication of an AI-based classification system.

According to an aspect of the present disclosure, there is provided a vulnerability analysis method for model replication of a target model, which is an AI-based classification model, the method comprising: constructing a training dataset comprising an unqueried dataset and a queried dataset by querying a query sampled from a pre-prepared dataset to the target model, wherein the pre-prepared dataset is unqueried; training a clone model for the target model with the training dataset, wherein the training dataset trains the clone model in different ways according to the unqueried dataset and the queried dataset; further training the clone model to minimize cross entropy between a classification result of the clone model and a classification result of the target model; and analyzing a vulnerability for model replication of the target model according to whether the clone model is generated within a preset total query budget.

According to an aspect of the present disclosure, there is provided a vulnerability analysis apparatus for model replication of a target model, wherein the target model is an artificial intelligence (AI)-based classification model, the vulnerability analysis apparatus comprising processing circuitry configured to: construct a training dataset comprising a queried dataset by querying a query sampled from a pre-prepared unqueried dataset to the target model; train a clone model for the target model in different ways according to the unqueried dataset and the queried dataset, and further train the clone model to minimize cross entropy between a classification result of the clone model and a classification result of the target model; and analyze a vulnerability of the model replication of the target model according to whether the clone model for the target model is generated within a preset total query budget.

According to an aspect of the present disclosure described above, by providing a vulnerability analysis device and method based on contrastive learning for model replication of an AI-based classification system, it is possible to evaluate the vulnerability for model replication of an AI-based classification system serviced in the form of a black box.

In addition, the number of queries required for model replication can be reduced through contrastive learning and minority class-priority sampling, thereby reducing attack costs and detection risks and improving the performance of the clone model.

In addition, it is possible to perform sophisticated clone model learning by performing contrastive learning in which high weights are given to input pairs with high similarity and confidence between target model outputs.

### BRIEF DESCRIPTION OF THE DRAWINGS

FIG. 1 is a diagram illustrating a general model replication method,

FIG. 2 is a diagram illustrating an internal block of a model replication vulnerability analysis device according to an embodiment of the present disclosure,

FIG. 3 is a diagram illustrating a structure of a clone model according to an embodiment of the present disclosure,

FIG. 4 is a diagram illustrating data augmentation in contrastive learning applied to a learning unit of FIG. 2,

FIG. 5 is a diagram illustrating an operation of scheduling entropy-based sampling and minority class priority sampling in a data management unit of FIG. 2,

FIG. 6 is a flowchart illustrating an operation of a model replication vulnerability analysis device according to an embodiment of the present disclosure, and

FIG. 7 is a flowchart illustrating a detailed operation of a model replication vulnerability analysis device according to an embodiment of the present disclosure.

### DETAILED DESCRIPTION

A detailed description of the present disclosure refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure with respect to one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Hereinafter, exemplary embodiments of the present disclosure will be described in more detail with reference to the drawings.

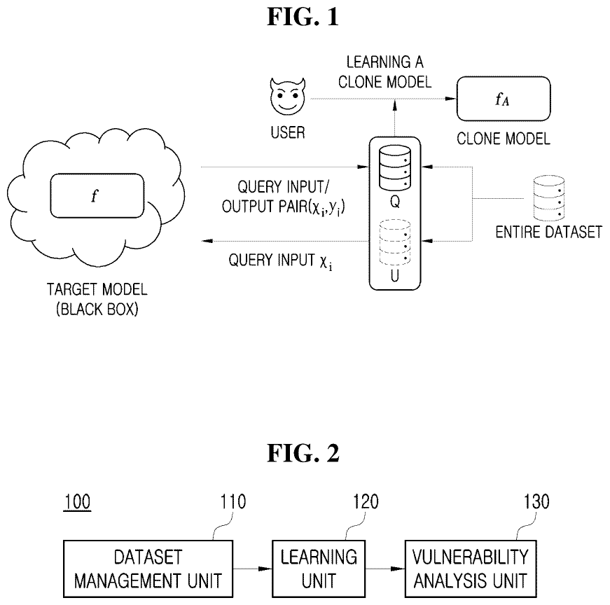

FIG. 1 is a diagram illustrating a general model replication method.

The user secures an entire dataset such as a public dataset, and transmits as a query a data point sampled from the entire dataset to the target model f, which is a target model. That is, the user transmits the query xᵢ to the target model to receive the output yᵢ of the target model for the query, and labels the query as the output to construct the queried dataset {xᵢ, yᵢ}.

The queried dataset is used for training the clone model f_{A}, and the higher the similarity between the output of the target model for the query and the output of the trained clone model, the more successful model replication is evaluated.

Meanwhile, in this general model duplication method, since the user needs to use the minimum number of queries to be queried, an unqueried dataset has more data than a queried dataset. Therefore, in an embodiment of the present disclosure to be described later, a method of reducing the number of queries by participating in the training of the clone model with the unqueried dataset will be described.

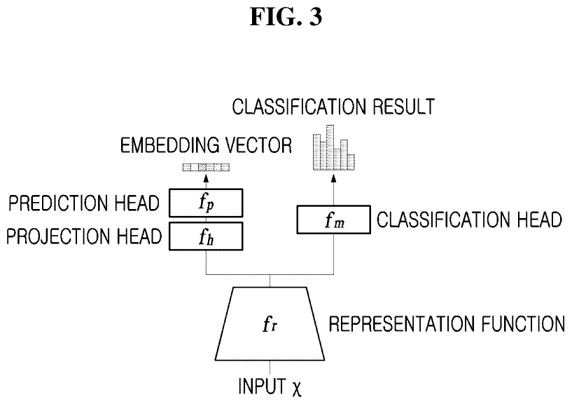

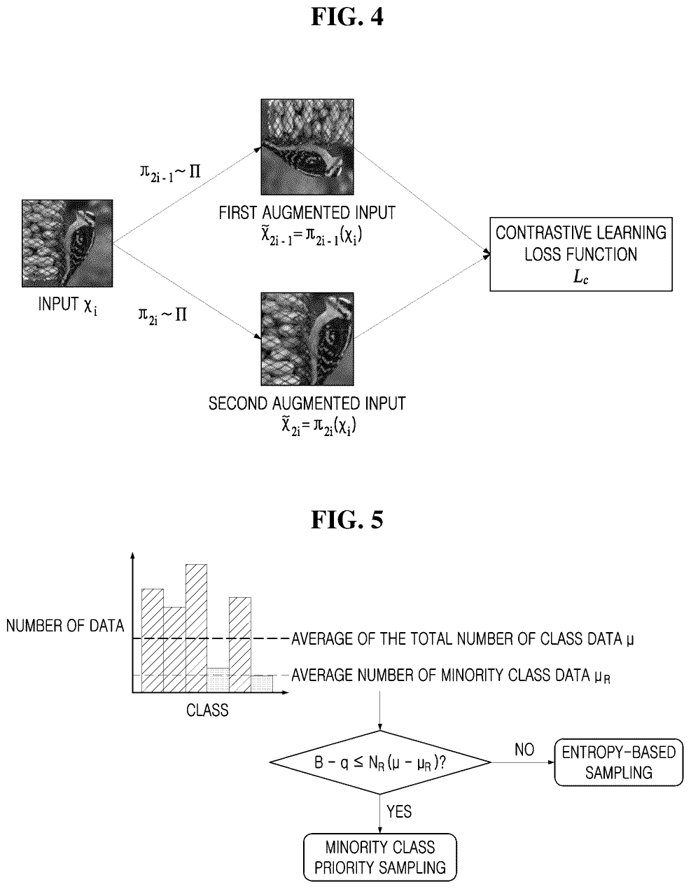

FIG. 2 is a device illustrating an internal block of a model replication vulnerability analysis device according to an embodiment of the present disclosure, FIG. 3 is a diagram illustrating a structure of a clone model according to an embodiment of the present disclosure, FIG. 4 is a diagram illustrating data augmentation in contrastive learning applied to a learning unit of FIG. 2, and FIG. 5 is a diagram illustrating an operation of scheduling entropy-based sampling and minority class priority sampling in a data management unit of FIG. 2.

Hereinafter, the target model function is expressed as f(·;w), and the clone model function is expressed as f_{A}(·; w_{A}), where w and w_{A} mean the learning parameters of the target model and the clone model, respectively. For a given input x(x∈R^{d}), the outputs f(x;w) and f_{A}(x;w_{A}) of the model function are the outputs of the softmax function of size K, where K represents the number of classification classes. Thus, the k-th element of the output represents the probability for the k-th class. Additionally, the entire dataset, including the queried dataset Q and the unqueried dataset U, is denoted by S.

The target model, which is an AI-based classification model according to an embodiment of the present disclosure, provides an output y=f(x;w) for a given query input x. The user transmits the unqueried data points included in the entire dataset S to the target model as a query to receive the output of the target model, and then labels the data points through the output to train the clone model f_{A}(·;w_{A}) in the form of supervised learning.

In the entire dataset S, the queried dataset is represented by Q:={(x,y):x∈S,y=f(x;w)} and the unqueried dataset is represented by U:=S\{x∈S:(x,y)∈Q}, and the size of the queried dataset is represented by |Q|=q and the size of the unqueried dataset is represented by |U|=u. The present disclosure provides a contrastive learning-based loss function that may utilize both the queried dataset Q and the unqueried dataset U for training a clone model.

The model replication vulnerability analysis device 100 shown in FIG. 2 includes a dataset management unit 110, a training unit 120, and a vulnerability analysis unit 130.

The dataset management unit 110 acquires the queried dataset U by querying a query obtained by sampling a part of the pre-prepared unqueried dataset Q into a target model that is an AI-based classification model, thereby constructing a training dataset comprising the unqueried dataset and the queried dataset.

In more detail, the dataset management unit 110 randomly samples N data points from the unqueried dataset U according to a uniform distribution, and queries the randomly sampled data points to the target model as a query to obtain N query input/output pairs

$${\{ ( {x}_{i} , {y}_{i} ) \}}_{i = 1}^{N} .$$

Then, the dataset management unit 110 adds the query input/output pair to the queried dataset Q

$$( Q = Q ⋃ {\{ ( {x}_{i} , {y}_{i} ) \}}_{i = 1}^{N} ) ,$$

excludes the query used in the query from the unqueried dataset U

$$( U = U ∖ {\{ {x}_{i} \}}_{i = 1}^{N} ) ,$$

and updates each of U and Q.

The target model includes a feature extraction unit for extracting a feature pattern for classification from an input query, and a classification unit for performing classification into at least one class from the extracted feature pattern.

As shown in FIG. 3, the clone model for the target model includes a path for performing classification including a feature extraction unit composed of a representation function and a classification unit composed of a classification head function, and further includes a path for contrastive learning for performing embedding on the feature pattern extracted from the feature extraction unit. The path for the contrastive learning includes a feature extraction unit and an embedding unit, and the embedding unit is composed of a projection head function and a prediction head function.

Here, the representation function is represented by fᵣ(·;wᵣ):R^{d}→R^{a}, and the classification head function is represented by fₘ(·;wₘ):R^{a}→Δ^{K}, where wᵣ and wₘ mean parameters of the representation function and the classification head function, respectively. Here, R denotes a real space, Δ denotes a probability simplex, d denotes a dimension of input data, a denotes an output dimension of a representation function, and K denotes the number of classes of a classification task performed by the target model and the clone model.

The entire function f_{A} of the clone model for classification may be expressed as Equation 1 below.

$${f}_{A} ( \cdot ; {w}_{r} , {w}_{m} ) := {f}_{m} \cdot {f}_{r} ( \cdot ) \qquad Equation 1$$

In addition, the clone model requires an additional layer capable of embedding the output of the representation function for contrastive learning. Accordingly, in the present disclosure, a projection head function fₕ(·;wₕ):R^{a}→R^{a′} and a prediction head function fₚ(·;wₕ):R^{a′}→R^{a′} are introduced into the clone model. Here, wₕ and wₚ mean parameters of the projection head function and the prediction head function, respectively, and a and a′ represent the embedding dimensions. In addition, the embedding vectors z∈R^{a′} and z′∈R^{a′} for the input x used for the contrastive learning are defined by Equation 2 below.

$$z = {f}_{h} \cdot {f}_{r} ( x ) , \qquad Equation 2$$

$${z}^{′} = {f}_{p} \cdot {f}_{h} \cdot {f}_{r} ( x )$$

The training unit 120 trains the clone model with the training dataset built through the dataset management unit 110, and in particular, trains the clone model in different ways according to the unqueried dataset and the queried dataset.

In more detail, the learning unit 120 generates a positive pair (POSITIVE PAIR) for contrastive learning by augmenting the unqueried dataset and the queried dataset as shown in FIG. 4. A random input transform distribution Π is defined to generate the positive pair, and the random input transform distribution may include universally utilized input transforms such as crop, rotation, color jitter, and the like, and the probability for each transform may be arbitrarily selected by the user.

That is, the learning unit 120 may perform the input conversion function corresponding to twice the size u of the unqueried dataset in the random input conversion distribution Π. A total of 2u augmented inputs are generated by sampling as shown in (π₁, . . . , π₂ᵤ)˜Π, and applying two sampled input transformation functions to each input data of U. That is, a first augmented input \tilde{x}₂ᵢ₋₁=π₂ᵢ₋₁(xᵢ) and a second augmented input \tilde{x}₂ᵢ=π₂ᵢ(xᵢ) are generated by augmenting the original data xᵢ, and in the present disclosure, the first and second augmented inputs are defined as a positive pair.

Then, the training unit 120 trains the clone model in a self-supervised contrastive learning method for the unqueried dataset. That is, the clone model is trained by the self-supervised contrastive learning method which induces the similarity of the result of embedding the feature pattern between the data points corresponding to the positive pair of the non-quality dataset to be maximized.

Here, an index set including index pairs (2i−1, 2i) and (2i, 2i−1) of all positive pairs augmented from the same existing input is denoted as P, and in this case, the loss function of the self-supervised contrastive learning L_{c}^{self} is defined as Equation 3 below.

$${L}_{c}^{self} ( {w}_{r} , {w}_{h} , {w}_{p} ) = - {E}_{( {π}_{1} , … , {π}_{2 q} ) ∼ Π} [ \frac{1}{2 \vert P \vert} {\sum }_{( i , j ) ∈ P} ( {z}_{i}^{T} {z}_{j}^{′} + {z}_{j}^{T} {z}_{i}^{′} ) ] \qquad Equation 3$$

Here,

$${z}_{i}^{′}$$

and zᵢ denotes an embedding vector for an augmented input \tilde{x}ᵢ, and may be expressed as

$${z}_{i}^{′} = {f}_{p} \cdot {f}_{h} \cdot {f}_{r} ( {\tilde{x}}_{i} ) ,$$

and zᵢ=fₕ°fᵣ(\tilde{x}ᵢ), respectively,

$${z}_{j}^{′}$$

and zⱼ denotes an embedding vector for an augmented input \tilde{x}ⱼ, and may be expressed as

$${z}_{j}^{′} = {f}_{p} \cdot {f}_{h} \cdot {f}_{r} ( {\tilde{x}}_{j} ) ,$$

and zⱼ=fₕ°fᵣ(\tilde{x}ⱼ), respectively.

In addition, the learning unit 120 samples input transform functions corresponding to twice the size q of the queried dataset in the random input transform distribution Π as (\hat{π}₁, . . . , \hat{π}_{2q})˜Π, and generates a total of 2q augmented inputs by applying two sampled input transform functions to each input data of Q. That is, different original data xᵢ and yᵢ labeled with the same class are augmented to generate a first augmented input (\hat{x}₂ᵢ₋₁,ŷ₂ᵢ₋₁)=(\hat{π}₂ᵢ₋₁(xᵢ),yᵢ), and a second augmented input (\hat{x}₂ᵢ,ŷ₂ᵢ)=(\hat{π}₂ᵢ(xᵢ),yᵢ).

Then, the training unit 120 trains the clone model in a supervised contrastive learning method based on label information that is a result of a query on the target model for the queried dataset. In this case, the label information may be expressed as a probability for each of at least one class, and the higher the similarity of the label information and the higher the confidence, the higher the weight for adjusting the intensity of the contrastive learning is given to train the clone model.

In the present disclosure, a method of performing supervised contrastive learning based on label information expressed as a probability for each class is defined as a soft-supervised contrastive learning method, and the loss function of the soft-supervised contrastive learning

$${L}_{c}^{soft}$$

is defined as Equation 4 below.

$${L}_{c}^{soft} ( {w}_{r} , {w}_{h} , {w}_{p} ) = - {E}_{( {\hat{π}}_{1} , … , {\hat{π}}_{2 q} ) ∼ \hat{Π}} [ {\sum }_{i = 1}^{2 q} {\sum }_{j = 1}^{2 q} {η}_{ij} ( {\hat{z}}_{i}^{T} {\hat{z}}_{j}^{′} + {\hat{z}}_{j}^{T} {\hat{z}}_{i}^{′} ) ] \qquad Equation 4$$

Here,

$${\hat{z}}_{i}^{′}$$

zᵢ are embedding vectors for the augmented input \hat{x}ᵢ and may be expressed as

$${\hat{z}}_{i}^{′} = {f}_{p} ∘ {f}_{h} ∘ {f}_{r} ( {\hat{x}}_{i} ) ,$$

and \hat{z}ᵢ=fₕ°fᵣ(\hat{x}ᵢ), respectively,

$${\hat{z}}_{j}^{′}$$

and \hat{z}ⱼ are embedding vectors for the augmented input \hat{x}ⱼ and may be expressed as

$${\hat{z}}_{j}^{′} = {f}_{p} ∘ {f}_{h} ∘ {f}_{r} ( {\hat{x}}_{j} ) ,$$

and \hat{z}ⱼ=fₕ°fᵣ(\hat{x}ⱼ), respectively.

nᵢⱼ is a weighting factor for adjusting the contrastive learning intensity for each positive pair, and therefore, as the nᵢⱼ value increases, the contrastive learning of higher intensity is performed. In this case, nᵢⱼ is defined as Equation 5 below in order to give a large coefficient to only a case having high similarity and high confidence in the output value of the target model corresponding to the two positive pairs.

$${η}_{ij} := {1}_{[ i \neq j ]} ( 1 + \frac{H ( {\hat{y}}_{i} )}{log K} ) ( 1 + \frac{H ( {\hat{y}}_{j} )}{log K} ) cos ∠ ( {\hat{y}}_{i} , {\hat{y}}_{j} ) \qquad Equation 5$$

Here, cos denotes a cosine function, ∠(a,b) denotes an angle between vectors a and b, H(·) denotes Shannon Entropy, and K denotes the total number of classes. In addition,

$$1 + \frac{H ( \cdot )}{log K}$$

is a form of a formula designed to have a value of 0 when the confidence of the output value of the target model is minimum (when the maximum probability value of the output of the target model is 100/K %) and a value of 1 when the confidence of the output value of the target model is maximum (when the maximum probability value of the output of the target model is 100%).

In the present disclosure, two loss functions calculated through Equations 4 and 5 described above are combined as shown in Equation 6 below to simultaneously utilize the queried dataset and the unqueried dataset for training.

$${L}_{C} ( {w}_{r} , {w}_{h} , {w}_{p} ) = {L}_{c}^{self} ( {w}_{r} , {w}_{h} , {w}_{p} ) + λ {L}_{c}^{soft} ( {w}_{r} , {w}_{h} , {w}_{p} ) \qquad Equation 6$$

Here, λ>0 is a hyper parameter (any positive real number) for balancing between two loss functions.

In addition, the learning unit 120 additionally trains the clone model to minimize cross entropy of the classification result of the clone model and the classification result of the target model. The cross entropy loss function Lₘ used in this case may be defined as in Equation 7 below.

$${L}_{m} ( {w}_{r} , {w}_{m} ) = - \frac{1}{q} {\sum }_{i = 1}^{q} {\sum }_{l = 1}^{K} {( {y}_{i} )}_{k} log ( {{f}_{A} ( {x}_{i} ; {w}_{r} , {w}_{m} )}_{l} ) \qquad Equation 7$$

As described above, the learning unit 120 repeatedly and alternately optimizes the loss functions L_{c}(wᵣ, wₕ, wₚ) and Lₘ(wᵣ, wₘ) to train the clone model. In the k-th iteration, the clone model first updates the learning parameter by minimizing the loss function L_{c} for the contrastive learning

$$( {w}_{r}^{k + \frac{1}{2}} , {w}_{h}^{k + 1} , {w}_{p}^{k + 1} = arg {min}_{{w}_{r} , {w}_{h} , {w}_{p}} {L}_{c} ( {w}_{r} , {w}_{h} , {w}_{p} ) ) ,$$

and then updates the learning parameter by minimizing the loss function Lₘ with the start point of

$${w}_{r}^{k + \frac{1}{2}} \cdot ( {w}_{r}^{k + 1} , {w}_{m}^{k + 1} = arg {min}_{{w}_{r} , {w}_{m}} {L}_{m} ( {w}_{r} , {w}_{m} ) )$$

When the primary learning of the clone model is completed, the dataset management unit 110 determines the degree of imbalance of the classification class according to whether the size of the queried dataset used for the learning of the clone model satisfies a preset condition, and performs entropy-based sampling or minority class priority sampling according to the degree of imbalance of the classification class to sample the query to be queried to the target model.

Here, the entropy-based sampling is to sample data close to a decision boundary of a model as a query input, and the minority class priority sampling is to preferentially sample data of a minority class as a query input in order to solve a class imbalance of a queried dataset.

More specifically, entropy-based sampling is to measure the entropy for the output of the clone model for the non-query data xᵢ∈U, and to sample the N data with the highest entropy as a query input. Here, N is any positive integer. In this case, the entropy for xᵢ∈U is calculated as in Equation 8 below.

$$- {\sum }_{l = 1}^{K} {{f}_{A} ( {x}_{i} )}_{l} log {{f}_{A} ( {x}_{i} )}_{l} \qquad Equation 8$$

Next, before describing the minority class priority sampling, a minority class having the smallest number of input data in the queried dataset Q is indicated as yₙ, and a set of input data having a class yₙ among the input data of Q is indicated as Q_{y}_{ₙ}.

Minority class priority sampling is to measure a density score by applying a kernel density estimation to input data belonging to Q_{y}_{ₙ}, among data of a unqueried dataset, and to sample N inputs from U having the highest density score as query inputs. Here, N is any positive integer. In this case, the density value for xⱼ∈U is calculated as in Equation 9 below.

$${\sum }_{{x}_{i} ∈ {Q}_{{y}_{n}}} x ( {f}_{r} ( {x}_{j} ; {w}_{r} ) - {f}_{r} ( {x}_{i} ; {w}_{r} ) , σ ) \qquad Equation 9$$

Here, x(·, σ) is a Gaussian kernel function having a bandwidth of σ>0, and σ is an arbitrary positive real number.

On the other hand, entropy-based sampling may sample query input adjacent to the decision boundary, but it is highly likely to deepen class imbalance of the queried dataset Q, and minority class priority sampling may alleviate class imbalance, but has a disadvantage in that it is possible to sample query input far away from the decision boundary. Accordingly, as shown in FIG. 5, the present disclosure proposes a method of scheduling two samplings, that is, minority class priority sampling and entropy-based sampling, according to the degree of classification class imbalance of the queried dataset Q.

The dataset management unit 110 performs scheduling to perform minority class priority sampling according to determination that the degree of the classification class imbalance of the Q is severe when the condition as shown in Equation 10 below is satisfied, and performs entropy-based sampling according to determination that the degree of the classification class imbalance of the Q is not severe when the condition is not satisfied.

$$B - q \leq {N}_{R} \cdot ( μ - {μ}_{R} ) \qquad Equation 10$$

Here, B is the predefined total query budget, q is the size of the queried dataset, μ is the average of the number of data of the entire class, μ_{R} is the average of the number of data of the minority class less than μ, and N_{R} is the number of the minority class.

The vulnerability analysis unit 130 analyzes the vulnerability for model replication of the target model according to whether a clone model for the target model is generated within the preset total query budget. That is, the vulnerability analysis unit 130 analyzes that the vulnerability is high when the clone model is generated by a query within the total query budget, and analyzes that the vulnerability is low when a query exceeding the total query budget is required to generate the clone model.

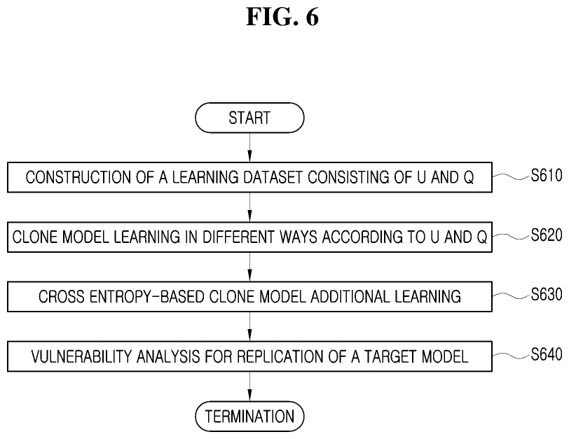

FIG. 6 is a flowchart illustrating an operation of a model replication vulnerability analysis device according to an embodiment of the present disclosure.

The model replication vulnerability analysis device builds a training dataset comprising a unqueried dataset U and a queried dataset Q. In operation S610, the queried dataset Q is obtained by querying the target model with a query obtained by sampling a portion of the unqueried dataset U.

Then, the model replication vulnerability analysis device learns the clone model in different ways according to the unqueried dataset U and the queried dataset Q S620, and additionally learns the clone model based on the cross entropy between the classification result of the clone model and the classification result of the target model. S630

Thereafter, the model replication vulnerability analysis device analyzes the vulnerability for model replication of the target model according to whether a clone model for the target model is generated with a query within a preset total query budget. S640

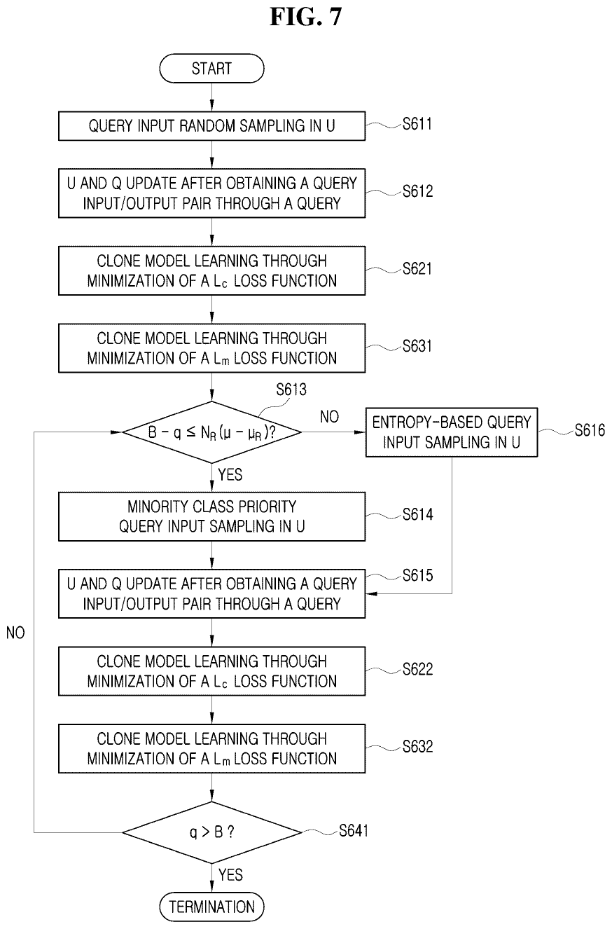

FIG. 7 is a flowchart illustrating a detailed operation of a model replication vulnerability analysis device according to an embodiment of the present disclosure.

The replication vulnerability analysis device randomly samples a query input from the unqueried dataset U S611, obtains a query input/output pair through a query for a target model of the randomly sampled query input, and then updates the datasets U and Q. S612

The replication vulnerability analysis device trains a clone model by minimizing a Lc loss function in which a loss function of supervised contrastive learning

$${L}_{c}^{self}$$

and a loss function of soft-supervised contrastive learning

$${L}_{c}^{soft}$$

are combined S621, and additionally trains the clone model by minimizing a cross-entropy loss function Lₘ. S631

When the primary learning is completed through S621 and S631, the replication vulnerability analysis device checks whether a condition for determining the degree of imbalance of the classification class of the queried dataset Q B−q≤N_{R}·(μ−μ_{R}) is satisfied. S613

As a result of the check of S613, the replication vulnerability analysis device preferentially samples the minority class as the query input in the unqueried dataset U when the condition is satisfied S614, and samples the query input based on entropy in the unqueried dataset U when the condition is not satisfied. S616

The replication vulnerability analysis device that samples the query input through S614 and S616 updates the datasets U and Q after acquiring the query input/output pair through the query for the target model. S615

Then, the replication vulnerability analysis device trains the clone model through minimization of the Lc loss function S622, and further trains the clone model through minimization of the cross entropy loss function Lₘ. S632

Thereafter, the replication vulnerability analysis device checks whether the size q of the queried dataset Q exceeds the total query budget B S641, and if q is less than or equal to B, proceeds to S613 and repeats the following steps. When the q is greater than the B as a result of the S641 test, the replication vulnerability analysis device ends the entire operation.

In FIGS. 6 and 7, the operation of the dataset management unit 110 of the replication vulnerability analysis device 100 is numbered S610 times, the operation of the learning unit 120 is numbered S620 and S630 times, and the operation of the vulnerability analysis unit 130 is numbered S640 times.

The vulnerability analysis method for model replication of the AI-based classification system of the present disclosure may be implemented in the form of program instructions that may be performed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure or may be known to and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

We claim:

1. A vulnerability analysis method for model replication of a target model, wherein the target model is an artificial intelligence (AI)-based classification model, the method comprising:
constructing a training dataset comprising an unqueried dataset and a queried dataset by querying a query sampled from a pre-prepared dataset to the target model, wherein the pre-prepared dataset is unqueried;
training a clone model for the target model with the training dataset, wherein the training dataset trains the clone model in different ways according to the unqueried dataset and the queried dataset;
further training the clone model to minimize cross entropy between a classification result of the clone model and a classification result of the target model; and
analyzing a vulnerability for model replication of the target model according to whether the clone model is generated within a preset total query budget.

2. The vulnerability analysis method of claim 1, wherein the training the clone model comprises training the clone model in a self-supervised contrastive learning method for the unqueried dataset, and training the clone model in a supervised contrastive learning method based on label information for the queried dataset, wherein the label information is a result of a query on the target model.

3. The vulnerability analysis method of claim 2, wherein the target model comprises: a feature extraction unit configured to extract a feature pattern for classification from an input query; and a classification unit configured to perform classification into at least one class from the extracted feature pattern, and wherein the clone model comprises a path for performing classification including the feature extraction unit and the classification unit, and further comprises a path for contrastive learning for performing embedding on the feature pattern extracted from the feature extraction unit.

4. The vulnerability analysis method of claim 3, wherein the training the clone model further comprises: generating a positive pair for contrastive learning by augmenting the unqueried dataset and the queried dataset through a random input transformation distribution.

5. The vulnerability analysis method of claim 4, wherein the training the clone model comprises:
training the clone model by the self-supervised contrastive learning method that induces similarity of a result of embedding the feature pattern between data points corresponding to the positive pair of the unqueried dataset to be maximized; and
inducing the similarity of the result of embedding the feature pattern between the data points corresponding to the positive pair of the queried dataset to be maximized, wherein the training the clone model by the supervised contrastive learning method is performed by considering different queried datasets as the positive pair based on the label information.

6. The vulnerability analysis method of claim 5, wherein the label information is expressed as at least one class-specific probability, and wherein the training the clone model comprises training the clone model by assigning a higher weight to adjust an intensity of the contrastive learning as the positive pair has a higher similarity and higher confidence of the label information.

7. The vulnerability analysis method of claim 1, wherein the constructing of the training dataset comprises obtaining the queried dataset by querying the target model with a query obtained by randomly sampling a portion of the unqueried dataset according to a uniform distribution.

8. The vulnerability analysis method of claim 1, wherein the constructing of the training dataset further comprises: determining a degree of imbalance of a classification class according to whether a size of a queried dataset used for training the clone model in which the further training is completed satisfies a preset condition, and when the size of the queried dataset satisfies the preset condition, performing minority class priority sampling to obtain the queried dataset.

9. The vulnerability analysis method of claim 8, wherein when the size of the queried dataset does not satisfy the preset condition, entropy-based sampling is performed to obtain the queried dataset.

10. The vulnerability analysis method of claim 8, wherein the preset condition is defined based on total query budget, size of the queried dataset, an average of an amount of data of an entire class, an average of an amount of data of minority classes, or an amount of decimal classes.

11. The vulnerability analysis method of claim 8, wherein the minority class priority sampling measures a density score for data corresponding to a minority class among data of the unqueried dataset, and samples data having a highest measured density score by the query.

12. The vulnerability analysis method of claim 9, wherein the entropy-based sampling measures entropy for an output of the clone model with respect to data of the unqueried dataset to sample data having a highest entropy to the query.

13. A vulnerability analysis apparatus for model replication of a target model, wherein the target model is an artificial intelligence (AI)-based classification model, the vulnerability analysis apparatus comprising processing circuitry configured to:
construct a training dataset comprising a queried dataset by querying a query sampled from a pre-prepared unqueried dataset to the target model;
train a clone model for the target model in different ways according to the unqueried dataset and the queried dataset, and further train the clone model to minimize cross entropy between a classification result of the clone model and a classification result of the target model; and
analyze a vulnerability of the model replication of the target model according to whether the clone model for the target model is generated within a preset total query budget.

14. The vulnerability analysis apparatus of claim 13, wherein the processing circuitry is further configured to train the clone model in a self-supervised contrastive learning method for the unqueried dataset, and trains the clone model in a supervised contrastive learning method based on label information for the queried dataset, wherein the label information is a result of a query on the target model.

15. The vulnerability analysis apparatus of claim 14, wherein the target model comprises: a feature extraction unit configured to extract a feature pattern for classification from an input query; and a classification unit configured to perform classification into at least one class from the extracted feature pattern, and wherein the clone model comprises a path for performing classification including the feature extraction unit and the classification unit, and further comprises a path for contrastive learning for performing embedding on the feature pattern extracted from the feature extraction unit.

16. The vulnerability analysis apparatus of claim 15, wherein the processing circuitry is further configured to generate a positive pair for contrastive learning by augmenting the unqueried dataset and the queried dataset through a random input conversion distribution.

17. The vulnerability analysis apparatus of claim 16, wherein the processing circuitry is further configured to:
train the clone model by the self-supervised contrastive learning method that induces similarity of a result of embedding the feature pattern between data points corresponding to the positive pair of the unqueried dataset to be maximized; and
train the clone model by the supervised contrastive learning method by inducing the similarity of the result of embedding the feature pattern between the data points corresponding to the positive pair of the queried dataset to be maximized, and considering different queried datasets as the positive pair based on the label information.

18. The vulnerability analysis apparatus of claim 17, wherein the label information is expressed as at least one class-specific probability, and wherein the processing circuitry is further configured to train the clone model by giving a higher weight for adjusting an intensity of the contrastive learning as the positive pair having a higher similarity and higher confidence of the label information is given.

19. The vulnerability analysis apparatus of claim 13, wherein the processing circuitry is further configured to obtain the queried dataset by querying the target model with a query obtained by randomly sampling a portion of the unqueried dataset according to a uniform distribution.

20. The vulnerability analysis apparatus of claim 13, wherein the processing circuitry is further configured to: determine a degree of imbalance of a classification class according to whether a size of a queried dataset used for training the clone model in which the further training is completed satisfies a preset condition; and based on the size of the queried dataset satisfying the preset condition, perform minority class priority sampling to obtain the queried dataset.

21. The vulnerability analysis apparatus of claim 20, wherein the processing circuitry is further configured to obtain the queried dataset by performing entropy-based sampling when the size of the queried dataset does not satisfy the preset condition.

22. The vulnerability analysis apparatus of claim 20, wherein the preset condition is defined based on total query budget, size of the queried dataset, an average of the amount of data of the entire class, an average of the amount of data of minority classes, or an amount of minority classes.

23. The vulnerability analysis apparatus of claim 20, wherein the minority class priority sampling measures a density score for data corresponding to a minority class among data of the unqueried dataset, and samples data having a highest measured density score as the query.

24. The vulnerability analysis apparatus of claim 21, wherein the entropy-based sampling measures entropy for an output of the clone model with respect to data of the unqueried dataset to sample data having a highest entropy to the query.
